(19) United States
(12) Patent Application Publication
(10) Pub. No.: US 2009/0171913 A1
(43) Pub. Date: Jul. 2, 2009

(54) MULTIMEDIA FILE CO-PROCESSING SYSTEM AND METHOD

(75) Inventors: Yu-Zhang Wen, Shenzhen City (CN); Zai-An Pan, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) Co., LTD, Shenzhen City (CN); HON HAI PRECISION INDUSTRY CO., LTD., Tu-Cheng (TW)

(21) Appl. No.: 12/206,719

(22) Filed: Sep. 8, 2008

(30) Foreign Application Priority Data
Dec. 29, 2007 (CN) 200710203550.3

(51) Int. Cl. G06F 7/00; G06F 17/30

(52) U.S. Cl. 707/3; 707/E17.014; 707/E17.044

(57) ABSTRACT

A mobile electronic system for sharing a multimedia playlist over a communication network between a sending mobile electronic device and a receiving mobile electronic device is disclosed. The system includes selecting one or more multimedia files from the plurality of multimedia files according to a predetermined selection and generating a co-process request and a proposed playlist, receiving a file status table transmitted from the receiving mobile electronic device and obtaining addresses of the multimedia file listed in the file status table to generate a co-processing playlist. The system further playing multimedia files listed in the co-processing playlist and if the status of the multimedia files in the file status table, and if the multimedia files do not exist in the receiving mobile electronic device, the sending mobile electronic device simultaneously sends the multimedia file to the receiving mobile electronic device.

### BACKGROUND

1. Field of the Invention

Embodiments of the present disclosure relate to sharing multimedia files, and more particularly to a system and method for sharing a multimedia playlist over a communication network.

2. Description of Related Art

Many electronic devices, such as cell phone, personal digital assistant (PDA), or computer may communicate with each other and play multimedia files, such as audio and video files. These multimedia files may be shared among other electronic files to be played synchronously. In one such method, a first communication device can request multimedia files to be played synchronously by a second communication device. The selected multimedia files are transmitted to a digital-to-analog converter (DAC) in order to convert the multimedia files into an analog signal, and then output the analog signal to an audio output device. Additionally, the selected multimedia files are mixed with a speech signal transmitted from an audio input device, such as microphone. The mixed signal is transmitted to the second communication device.

In the above mentioned method, in order to share the same multimedia file, the first communication device must first mix the speech signal transmitted from the audio input device with the multimedia file, and then transmit the mixed signal to the second communication device to output. Unfortunately, the process increases a load of the network between the first communication device and the second device, and the process furthermore requires a rapid transmitting speed and a stable network.

Therefore, what is needed is a multimedia file co-processing system to amend the aforementioned problems.

### SUMMARY

A multimedia file co-processing method for a sending mobile electronic device adapted to communicate with a receiving mobile electronic device over a communication network, the method comprising: selecting multimedia files to be played synchronously between the sending mobile electronic device and the receiving mobile electronic device, and generating a proposing playlist according to the selected multimedia files; generating a co-process request for the receiving mobile electronic device; sending the co-process request and the proposing playlist to the receiving mobile electronic device; receiving the co-process request and the proposing playlist from the sending mobile electronic device; generating a file status table to record if the multimedia file listed in the proposing playlist exist in the receiving mobile electronic device; obtaining file addresses of the multimedia files that exist in the receiving mobile electronic device to generate a second co-processing playlist; sending the file status table to the sending mobile electronic device; receiving the file status table transmitted from the receiving mobile electronic device and obtaining file addresses of the multimedia files listed in the file status table to generate a first co-processing playlist; reading multimedia files listed in the first co-processing playlist from the sending mobile electronic device to play, and if the multimedia files do not exist in the receiving mobile electronic device according to the file status table, the sending mobile electronic device simultaneously sending the multimedia file to the receiving mobile electronic device during the playing process; playing the multimedia files listed in the second co-processing playlist if the multimedia files exist in the mobile electronic system, and receiving multimedia file from the sending mobile electronic device if the multimedia files do not exist in the receiving electronic device.

Other advantages and novel features will be drawn from the following detailed description of the preferred embodiment with reference to the attached drawings.

### BRIEF DESCRIPTION OF THE DRAWINGS

The components of the drawings are not necessarily drawn to scale, the emphasis instead being placed upon clearly illustrating the principles of the multimedia files co-processing system. Moreover, in the drawings, like reference numerals designate corresponding parts throughout several views.

FIG. 1 is an architectural diagram of one embodiment of a multimedia file co-processing system of the present disclosure.

FIG. 2 is a block diagram of one embodiment of main function modules of a sending party.

FIG. 3 is a block diagram of one embodiment of main function modules of a receiving party.

FIG. 4 is a flowchart of one embodiment of a multimedia file co-processing method.

### DETAILED DESCRIPTION OF CERTAIN INVENTIVE EMBODIMENTS

As used herein, the term, “multimedia files” or “multimedia file” refer to electronic audio and video files. It may be understood that a multimedia file may include a playlist listing one or more multimedia files to be executed/played by an electronic device. Furthermore, the multimedia file includes metadata, such as an artist name, an album name, and a file address, for example.

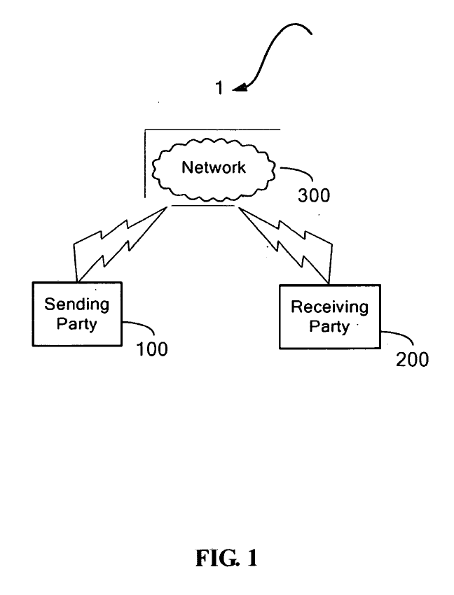

FIG. 1 is an architectural diagram of one embodiment of a multimedia file co-processing system 1 of the present disclosure. The system 1 includes a sending party 100 and a receiving party 200 communicating over a network 300. The sending party 100 and the receiving party 200 may share a same playlist between the two parties 100, 200 in order to play one or more multimedia files, such as a song file, existing on both of the two parties 100, 200. In one embodiment, the sending party 100 and the receiving party 200 may be any electronic device with a multimedia playing function and a vocal communication function, such as a personal digital assistant (PDA), a cell phone, or a computer, for example. The network 300 can be the Internet or a wireless network such as a general packet radio service (GPRS).

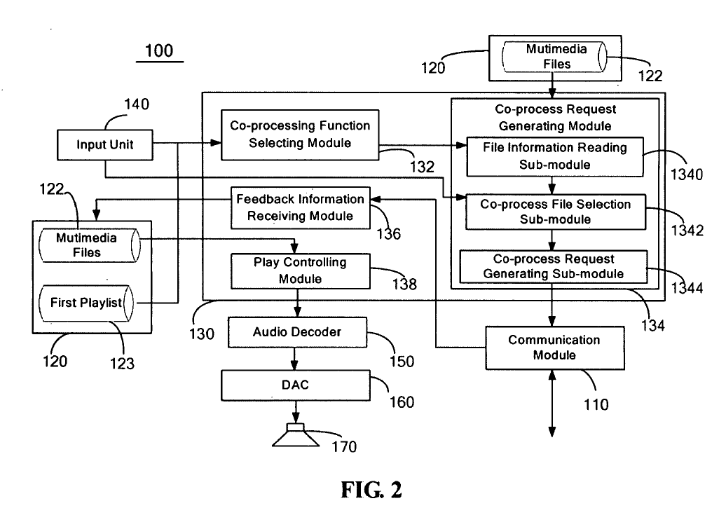

FIG. 2 is a block diagram of one embodiment of the sending party 100 including various function modules. The sending party 100 includes a data storage 120 configured for storing a plurality of multimedia files 122 and a first playlist 123. The first playlist 123 records any metadata of the multimedia files 122 and stores the metadata in a tabular form, in one embodiment, such as in Table 1. For example, in reference to Table 1, a first row shows “AA” as a multimedia file title, “John” as an artist name of the multimedia file, “A” as an album name of the multimedia file, and “XXXXXXX1” as a file address of the multimedia files 122. The data storage 120 may be a hard disk drive, a flash drive, for example.

TABLE 1

| Multimedia file | | | |
|---|---|---|---|
| title | Artist name | Album name | File address |
| AA | John | A | XXXXXXX1 |
| BB | Rose | B | XXXXXXX2 |
| CC | Cat | C | XXXXXXX3 |
| DD | Stone | D | XXXXXXX4 |

The sending party 100 further includes a processing unit 130. The processing unit 130 includes a co-processing function activating module 132, a co-process request generating module 134, a feedback information receiving module 136, and a play controlling module 138.

The co-processing function activating module 132 is configured for playing the multimedia files 122 of the sending party 100 according to operations of the user via an input unit 140.

The co-processing multimedia files generating module 134 is configured for determining which of the multimedia files 122 need to be synchronously played between the sending party 100 and the receiving party 200, and for generating a co-processing request according to a determined result. The co-processing multimedia files generating module 134 includes a file information reading sub-module 1340, a co-process file selection sub-module 1342, and a co-process request generating sub-module 1344.

The file information reading sub-module 1340 is configured for reading the first playlist 123 from the data storage 120, and displaying the first playlist 123 on a display (not shown) of the sending party 100.

The co-process file selection sub-module 1342 is configured for selecting multimedia files which have to be played synchronously between the two parties 100, 200 from the first playlist 123 according to selection inputs corresponding to the first playlist 123. For example, in reference to Table 1, multimedia files AA, BB, and CC in the first playlist 123 may be selected as multimedia files which have to be played synchronously between the two parties 100, 200. The selected multimedia files form a proposing playlist. The co-process request generating sub-module 1344 is configured for generating the co-process request for the proposing playlist, and sending the co-process request and the proposing playlist to the receiving party 200. After receiving the co-process request and the proposing playlist, the receiving party 200 generates a feedback information, in this embodiment, the feedback information is a file status table. The file status table records if each of the multimedia files listed in the proposing playlist exist in the sending party 200, such as Table 2 shows. The Multimedia file title column, Artist name column, and Album name column records the same content as the table 1. The statue column records a status indicting if the corresponding multimedia files exist in the receiving party 200. If the corresponding multimedia file exists in the sending party 200, “Yes” is written to the corresponding row under the status column. If the corresponding multimedia file does not exist in the sending party 200, “No” is written to the corresponding row under the status column. A detailed description on generating the file status table will be described below.

TABLE 2

| Multimedia file | | | |
|---|---|---|---|
| title | Artist name | Album name | Status |
| AA | John | A | Yes |
| BB | Rose | B | No |
| CC | Cat | C | Yes |

The feedback information receiving module 136 is configured for receiving the feedback information, namely the file status table, from the sending party 100 and obtaining file addresses (e.g., Desktop/Username/Music/My_life.mp3, for example) of the multimedia files listed in the file status table from the first playlist 123 to generate a first co-processing playlist, such as Table 3 shows.

TABLE 3

| Multimedia file | | | | |
|---|---|---|---|---|
| title | Artist name | Album name | Status | Address |
| AA | John | A | Yes | XXXXXX |
| BB | Rose | B | No | XXXXXX |
| CC | Cat | C | Yes | XXXXXX |

The play controlling module 138 is configured for controlling the multimedia files 122 listed in the first co-processing playlist to play. If the status of the multimedia file 122 in the status column of the first co-processing playlist is “Yes,” the play controlling module 138 reads the multimedia files 122 from the data storage 120 according to the corresponding file address recorded in the address column to play. If the status of the multimedia file 122 in the status column is “No,” the play controlling module 138 reads the multimedia files 122 from the data storage 120 according to the corresponding file address recorded in the address column to play, and simultaneously, sends the multimedia files 122 to receiving party 200 through the communication module 110.

During playing the multimedia file 122, the play controlling module 138 sends the multimedia files 122 to an audio decoder 150 to decode to digital audio information. The digital audio information is transmitted to a digital-to-analog converter (DAC) 160 to convert to analog information. The converted analog information is transmitted to the audio output device 170 to output.

In one embodiment, if the sending party 100 and the receiving party 200 are both cell phones, during sending the multimedia files 122 to the receiving party 200, the play controlling module 138 mixes the multimedia file 122 with a speech signal transmitted from an audio input device (not shown), such as microphone. The mixed signal is transmitted to the sending party 200.

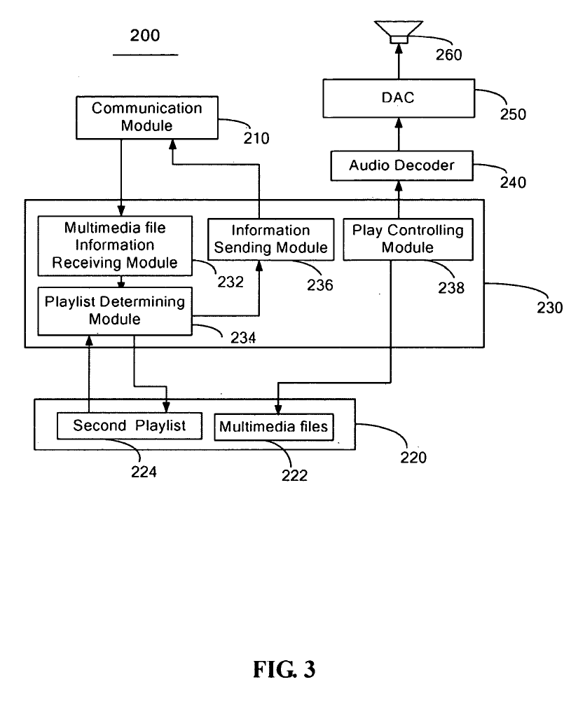

FIG. 3 is a block diagram of one embodiment of main function modules of the receiving party 200. The receiving party 200 includes a data storage 220 for storing a second playlist 224 and a plurality of multimedia files 222. The second playlist 224 records the same metadata of the multimedia files 222 as the first playlist 124. The receiving party 200 further includes a processing unit 230. The processing unit 230 includes a multimedia file information receiving module 232, a playlist determining module 234, an information sending module 236, and a play controlling module 238.

The multimedia file information receiving module 232 is configured for receiving the co-process request and the proposing playlist from the sending party 100 through a communication module 210 of the receiving party 200. The playlist determining module 234 determines if the multimedia files listed in the proposing playlist exist in the data storage 220 according to the metadata recorded in the proposing playlist and the second playlist 224 and generates the feedback information, namely the file statue tale as Table 2 shows. For example, if the multimedia file listed in the proposing playlist exists in the receiving party 200, the playlist determining module 234 writes “Yes” to corresponding row under the status column. If the corresponding multimedia file does not exist in the sending party 200, the playlist determining module 234 writes “No” to corresponding row under the status column. After status of all the multimedia file listed in the proposing list is determined, the playlist determining module 234 obtains addresses of the multimedia files which status are “Yes” in the file statue table and generates a second co-processing playlist, such as Table 4 shows.

TABLE 4

| Multimedia file | | | | |
|---|---|---|---|---|
| title | Artist name | Album name | Status | Address |
| AA | John | A | Yes | XXXXXX |
| BB | Rose | B | No | |
| CC | Cat | C | Yes | XXXXXX |

The feedback information sending module 236 is for sending the feedback information, namely the file status table to the sending party 100. The play controlling module 238 is configured for controlling the multimedia file 222 listed in the second co-processing playlist to play. If the status of the multimedia file 222 is “Yes” in the second co-processing playlist, the play controlling module 238 plays the multimedia files 222. During playing the multimedia file, the play controlling module 238 reads the multimedia files listed in the playlist from the data storage 220 according to the file address recorded in the playlist, and sends the read multimedia files to an audio decoder 250 of the sending party 100 to decode the multimedia files 222 to digital audio information. The decoded digital audio information is transmitted to a digital-to-analog converter (DAC) 260 of the receiving party 200 to convert the decoded digital information into analog information. The converted analog information is transmitted to the audio output device 270 to output. If the status of the multimedia file 222 is “No” in the playlist, the play controlling module 238 receives the multimedia file 222 from the sending party 100 through the communication module 210 and sends the received multimedia file 222 to an audio decoder 250 of the sending party 100 to decode the multimedia file 222 to digital audio information. The decoded digital audio information is transmitted to a digital-to-analog converter (DAC) 260 of the receiving party 200 to convert the decoded digital information into analog information. The converted analog information is transmitted to the audio output device 270 to output. If not receiving any multimedia files, the play controlling module 238 plays the next multimedia files listed in the second co-processing playlist. The data storage 220 may be a hard disk drive or a flash drive, for example.

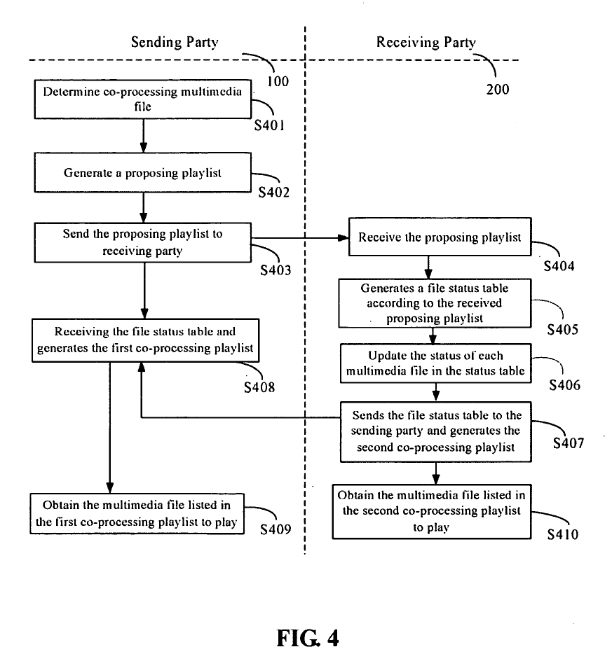

FIG. 4 is a flowchart of a multimedia file co-processing method of the present disclosure. In block S401, after the multimedia files co-processing function of the sending party 100 is activated, the sending party 100 determines which multimedia file listed in the first playlist 123 needs to be played synchronously between the two parties 100, 200 according to selection operations from the user. The detailed description of determining which multimedia files is to be played synchronously is described with respect to FIG. 2.

In block S402, the sending party 100 generates the proposing playlist according to the determined multimedia files.

In block S403, the sending party 100 sends the proposing playlist to the receiving party 200 via the communication module 110 of the sending party 100.

In block S404, the receiving party 200 receives the proposing playlist transmitted from the sending party 100.

In block S405, the receiving party 200 generates the file status table according to the received proposing playlist.

In block S406, the receiving party 200 updates the status of each multimedia file in the file status table. If the multimedia file listed in the proposing list exists in the proposing playlist, the receiving party 200 writes “Yes” to corresponding row under the status column of the file status table. If the multimedia file listed in the proposing list does not exist in the proposing playlist, the receiving party 200 writes “No” to the corresponding row under the status column of the file status table.

In block S407, after the status of all the multimedia files are determined, the receiving party 200 sends the file status table to the sending party 100, and simultaneously, obtains the address of the multimedia files whose status in the file status table is “Yes” to generate the second co-processing playlist.

In block S408, the sending party 100 receives the file status table, and obtains the address of all the multimedia files listed in the file status table to generate the first co-processing playlist.

In block S409, the sending party 100 reads the multimedia files listed in the first co-processing playlist from the data storage 120 of the sending party 100 to play, if the status of the multimedia file is “No”, during the playing process, and the sending party 100 simultaneously sends the multimedia files to the receiving party 200 through the communication module 110.

In block S410, if the status of the multimedia files listed in the second co-processing playlist is “Yes”, the receiving party 200 reads the multimedia files listed in playlist from the data storage 220 of the receiving party 200 to play, if the status of the multimedia files listed in the second co-processing playlist is “No”, the receiving party 200 receives the multimedia file transmitted form the sending party 100.

Although the present invention has been specifically described on the basis of a preferred embodiment, the present disclosure is not to be construed as being limited thereto. Various changes or modifications may be made to the embodiment without departing from the scope and spirit of the present disclosure.

What is claimed is:

1. A mobile electronic system for sharing a multimedia playlist over a communication network to a receiving mobile electronic device, the system comprising:
a data storage that stores a plurality of multimedia files;
a co-process request generating module configured for selecting one or more multimedia files from the plurality of multimedia files according to a predetermined selection, generating a co-process request according to the selected multimedia files, generating a proposed playlist according to the selected multimedia files, and sending the co-process request and the proposed playlist to the receiving mobile electronic device;
a feedback information receiving module configured for receiving a file status table transmitted from the receiving mobile electronic device and obtaining file addresses of the multimedia file listed in the file status table to generate a co-processing playlist, wherein the file status table records if the multimedia file listed in the proposing playlist exist in the receiving mobile electronic device; and
a play controlling module configured for playing multimedia files listed in the co-processing playlist from the data storage, and if the status of the multimedia files in the file status table implies that the multimedia file does not exist in the receiving mobile electronic device, during the playing process, the mobile electronic system simultaneously sending the multimedia file to the receiving mobile electronic device.

2. The system as described in claim 1, wherein the multimedia files are mixed with a speech signal transmitted from an audio input device first, and then transmitted to the receiving mobile electronic device wherein the multimedia files are mixed before sending the multimedia files to the receiving mobile electronic device.

3. A mobile electronic system for receiving a multimedia playlist over a communication network from a sharing mobile electronic device, the system comprising:
a data storage that stores a plurality of multimedia files;
a multimedia files information receiving module for receiving a co-process request and a proposing playlist from the sharing mobile electronic device, wherein the proposing playlist list one or more multimedia files of the mobile electronic system to be played;
a playlist determining module configured for generating a file status table to record if the one or more multimedia file listed in the proposing playlist exist in the data storage of the mobile electronic system, and obtains file addresses of the multimedia files that exist in the mobile electronic system to generate a co-processing playlist;
an information sending module configured for sending the file status table to the sharing mobile electronic device; and
a play controlling module configured for playing the multimedia files listed in the co-processing playlist from the data storage if the multimedia files exist in the mobile electronic system, and receiving multimedia files from the sharing mobile electronic device if the multimedia files does not exist in the mobile electronic system.

4. A multimedia file co-processing method for a sending mobile electronic device adapted to communicate with a receiving mobile electronic device over a communication network, the method comprising:
(a) selecting multimedia files to be played synchronously between the sending mobile electronic device and the receiving mobile electronic device, and generating a proposing playlist according to the selected multimedia files;
(b) generating a co-process request for the receiving mobile electronic device;
(e) sending the co-process request and the proposing playlist to the receiving mobile electronic device;
(f) receiving the co-process request and the proposing playlist from the sending mobile electronic device;
(g) generating a file status table to record if the multimedia file listed in the proposing playlist exist in the mobile electronic system;
(h) obtaining file addresses of the multimedia files that exist in the receiving mobile electronic device to generate a second co-processing playlist;
(i) sending the file status table to the sending mobile electronic device;
(j) receiving the file status table transmitted from the receiving mobile electronic device and obtaining file addresses of the multimedia files listed in the file status table to generate a first co-processing playlist;
(k) reading multimedia files listed in the first co-processing playlist from the sending mobile electronic device to play, and if the multimedia file does not exist in the receiving mobile electronic device according to the file status table, the sending mobile electronic device simultaneously sending the multimedia file to the receiving mobile electronic device during the playing process;
(l) playing the multimedia files listed in the second co-processing playlist if the multimedia files exist in the receiving mobile electronic device, and receiving multimedia file from the sending mobile electronic device if the multimedia files do not exist in the receiving electronic device.

5. The method as described in claim 4, further comprising:
sending a feedback signal to the sending mobile electronic device upon the condition that none of multimedia files listed in the proposing playlist exist in the receiving mobile electronic device;
receiving the feedback signal and going to block (a).
